(19) United States
(12) Patent Application Publication
(10) Pub. No.: US 2017/0081785 A1
(43) Pub. Date: Mar. 23, 2017

(54) CARBON FIBER RECLAMATION FROM COMPOSITE MATERIALS

(71) Applicant: Caterpillar Inc., Peoria, IL (US)

(72) Inventor: Kenneth Stonecipher, Metamora, IL (US)

(21) Appl. No.: 14/861,359

(22) Filed: Sep. 22, 2015

(51) Int. Cl. D01F 9/12; B01D 21/28; B04B 7/16; B01D 21/26

(52) U.S. Cl. CPC D01F 9/12; B01D 21/262; B01D 21/28; B04B 7/16

(57) ABSTRACT

Carbon fiber reclaimed from a composite part is described. The composite part may include the carbon fiber and a resin. The carbon fiber may be reclaimed from the composite part by a method comprising placing the composite part and a first solvent in an interior portion of a centrifuge insert that is defined by a wall having a plurality of perforations extending therethrough. The method may further comprise centrifuging the composite part and the first solvent contained in the centrifuge insert to allow extraction of the first solvent and at least a portion of the resin through the perforations of the centrifuge insert. The method may further comprise allowing the carbon fiber to collect in the interior portion of the centrifuge insert. The carbon fiber collected in the interior portion of the centrifuge insert may be at least partially separated from the resin.

### TECHNICAL FIELD

The present disclosure generally relates to carbon fibers and, more specifically, to methods of reclaiming carbon fibers from composite parts for re-use.

### BACKGROUND

Carbon fiber composites are being increasingly used for part fabrication in a number of industries, such as the automotive, aerospace, and military industries. As carbon fiber composite materials are lightweight and high in strength, such materials offer a number of advantages including improved fuel efficiencies for machines using them without compromising part durability. Carbon fiber composite materials include a matrix and a reinforcement. The reinforcement includes woven or non-woven carbon fibers, while the matrix is a polymer resin, such as epoxy resin.

Many methods exist to fabricate carbon fiber composites. In a dry layup process, layers of dry, woven or non-woven carbon fibers are laid up in a stack, and a resin matrix is subsequently applied or infused into the carbon fiber stack. In a wet layup process, each carbon fiber layer is coated or impregnated with resin during the layup process. The laminate stack may then be consolidated and cured by placing the stack in a vacuum bag and applying pressure and heat. There are many other alternative methods to fabricate carbon fiber composites as well.

While effective, carbon fibers and composite parts formed therefrom may be very expensive, particularly depending on the weave of the carbon fibers, the curing time used to fabricate the part, as well as the size and complexity of the part. In addition, the recycling of waste carbon fiber composite parts is often precluded as such parts cannot be melted and remolded into new parts without significant degradation. Given that the carbon fibers in carbon fiber composite materials are deeply impregnated with resin, it may be difficult to efficiently extract the resin from the carbon fibers for reuse of the carbon fibers. Methods of extracting pure carbon fiber from waste carbon fiber composite parts for incorporation into new parts are wanting. U.S. Pat. No. 6,245,822 discloses a method of recycling resin from mostly metallic composite waste articles by treatment with a decomposing solvent, but does not specifically target carbon fibers for reclamation and recycling.

As many industries may benefit from significantly reduced manufacturing costs that may result from the reuse of carbon fibers obtained from waste composite parts, there is clearly a need for effective methods for reclaiming pure carbon fiber from waste composite parts in significant yields. The present disclosure addresses this and other problems of the prior art.

### SUMMARY

In accordance with one aspect of the present disclosure, carbon fiber reclaimed from a composite part is disclosed. The composite part may include the carbon fiber and a resin. The carbon fiber may be reclaimed from the composite part by a method comprising placing the composite part and a first solvent in an interior portion of a centrifuge insert that is defined by a wall having a plurality of perforations extending therethrough. The method may further comprise centrifuging the composite part and the first solvent contained in the centrifuge insert to allow extraction of the first solvent and at least a portion of the resin through the perforations of the centrifuge insert, and allowing the carbon fiber to collect in the interior portion of the centrifuge insert. The carbon fiber collected in the interior portion of the centrifuge insert may be at least partially separated from the resin.

In accordance with another aspect of the present disclosure, a method for reclaiming carbon fiber from a composite part that includes the carbon fiber and a resin is disclosed. The method may comprise placing the composite part and methyl acetate in an interior portion of a centrifuge insert. The centrifuge insert may have a double-conical shape and may be defined by a wall having a plurality of perforations extending therethrough. The method may further comprise centrifuging the composite part and the methyl acetate contained in the centrifuge insert to allow extraction of the methyl acetate and at least a portion of the resin through the perforations of the centrifuge insert. In addition, the method may further comprise allowing the carbon fiber to collect in the interior portion of the centrifuge insert. The carbon fiber collected in the interior portion of the centrifuge insert may be at least partially separated from the resin.

In accordance with another aspect of the present disclosure, a centrifuge insert for reclaiming carbon fiber from a composite part that includes the carbon fiber and a resin is disclosed. The centrifuge insert may comprise a wall defining the centrifuge insert, a center, and two ends on opposing axial sides of the centrifuge insert with respect to a longitudinal axis of the centrifuge insert. A radial diameter of the centrifuge insert may increase gradually from the center to each of the two ends such that the centrifuge insert has a double-conical shape. The centrifuge insert may further comprise a plurality of perforations extending through the wall, and an interior portion configured to contain the composite part and a solvent during centrifugation. The resin and the solvent may be extracted through the perforations during centrifugation of the composite part, leaving the carbon fiber at least partially separated from the resin in the interior portion.

These and other aspects and features of the present disclosure will be more readily understood when read in conjunction with the accompanying drawings.

### BRIEF DESCRIPTION OF THE DRAWINGS

FIG. 1 is a schematic representation of carbon fiber reclaimed from a composite part, in accordance with the present disclosure.

FIG. 2 is a schematic representation of chopping the composite part into smaller pieces, in accordance with a method of the present disclosure.

FIG. 3 is a schematic representation of centrifuging the pieces of the composite part in a first solvent, in accordance with a method of the present disclosure.

FIG. 4 is a cross-sectional schematic representation of centrifuging the pieces of the composite part and the first solvent in a centrifuge insert, in accordance with a method of the present disclosure.

FIG. 5 is a side perspective view of the centrifuge insert of FIG. 4 shown in isolation, constructed in accordance with the present disclosure.

FIG. 6 is a schematic representation of sonicating the carbon fibers in the first solvent, in accordance with a method of the present disclosure.

FIG. 7 is a schematic representation of centrifuging the carbon fibers in a second solvent to obtain the pure, reclaimed carbon fiber, in accordance with a method of the present disclosure.

FIG. 8 is a cross-sectional schematic representation of centrifuging the carbon fibers in the second solvent in the centrifuge insert, in accordance with a method of the present disclosure.

FIG. 9 is a schematic representation of forging the reclaimed carbon fiber into a carbon sheet, constructed in accordance with a method of the present disclosure.

FIG. 10 is a flowchart of a series of steps that may be involved in reclaiming the carbon fiber from the composite part, in accordance with a method of the present disclosure.

### DETAILED DESCRIPTION

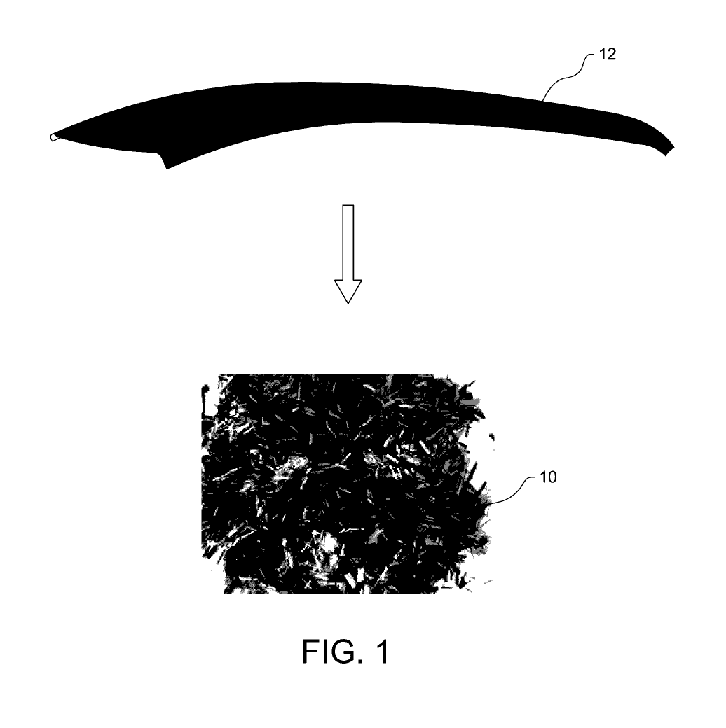

Referring now to the drawings, and with specific reference to FIG. 1, carbon fiber 10 reclaimed from a waste carbon fiber composite part 12 is shown. The composite part 12 may be any type of part used in various industries such as, but limited to, automotive, military, and aerospace industries, wherein at least a portion of the part 12 is formed from a carbon fiber composite material. As used herein, a carbon fiber composite material is a material that includes carbon fiber embedded in a polymer matrix consisting of one or more resins, such an epoxy resin or other types of thermoset or thermoplastic resins. Prior to reclamation, the carbon fiber in the composite part 12 may be woven, nonwoven unidirectional, or nonwoven randomly-oriented fibers. As reclaimed from the composite part 12 according to the methods disclosed herein, the carbon fiber 10 may be randomly-oriented (or uncombed) and chopped into smaller fragments, as shown.

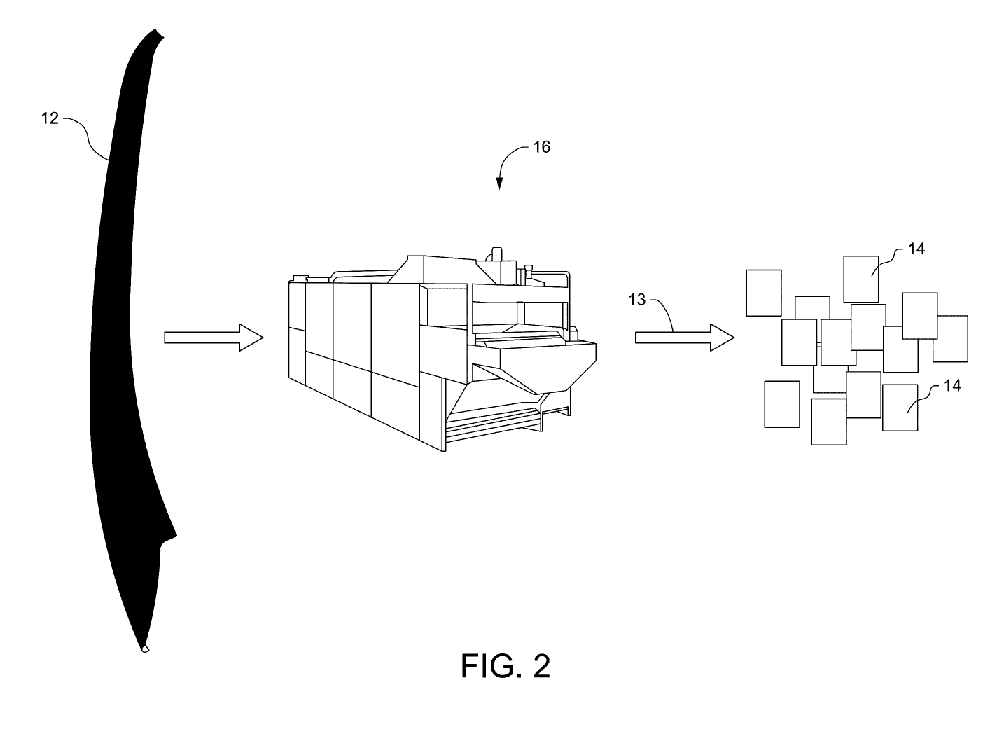

Turning now to FIGS. 2-4 and 6-8, a series of steps that may be involved in reclaiming carbon fiber from the composite part 12 are schematically depicted. Namely, the steps depicted in FIGS. 2-4 and 6-8 are designed to effectively extract the resin from the carbon fibers in the composite part 12, providing pure carbon fibers in high recovery. Initially, the composite part 12 may be chopped 13 into smaller pieces 14 of composite material such that the carbon fiber in each piece 14 remains impregnated with resin (see FIG. 2). The composite part 12 may be chopped into the smaller pieces 14 using a suitable chopping machine 16 apparent to those with ordinary skill in the art, or another suitable cutting machine or tool. The pieces 14 of the composite part 12 may have dimensions of about one inch or less to improve solvent penetration into the pieces 14 and resin extraction from the carbon fibers, as will be explained in further detail below.

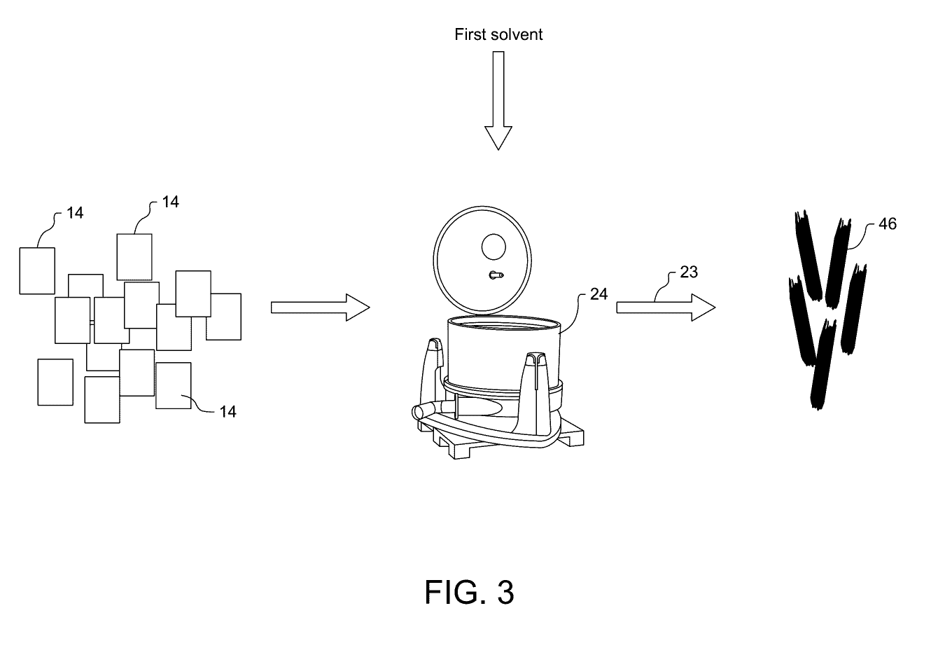

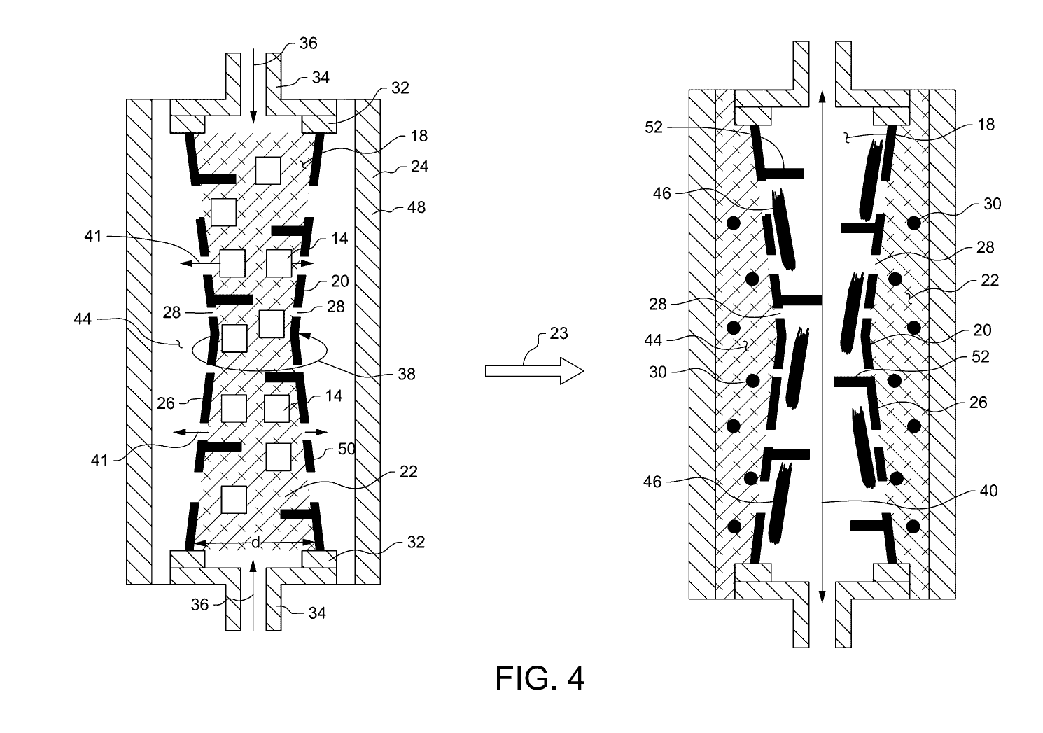

Referring specifically now to FIGS. 3-4, the chopped pieces 14 of the composite part 12 may then be placed in an interior portion 18 of a centrifuge insert 20 along with a first solvent 22 for a first centrifugation step 23. The first solvent 22 may be various solvents capable of softening or penetrating into the composite material of the pieces 14 to allow the extraction of at least a portion of the resin from the carbon fiber without damaging the carbon fiber. In this regard, the resin may have a higher affinity for or a higher solubility in the first solvent 22 than the carbon fiber, such that the resin may be at least partially liquefied or dissolved in the presence of the first solvent, leaving the carbon fiber in solid phase. The first solvent 22 may be methyl acetate, although other solvents, such as ethyl acetate or other alkyl acetates, may be used in some circumstances. One advantage of using methyl acetate as the first solvent is that it is biodegradable, nontoxic, and reusable.

The centrifuge insert 20 may be designed to fit inside of a centrifuge 24, as shown in FIG. 4. The centrifuge insert 20 may be defined by a wall 26 having perforations 28 extending therethrough to permit extraction of the resin and the first solvent during centrifugation. Furthermore, the centrifuge insert 20 may have a cap portion 32 on one or both axial sides of the insert 20 upon which one or more gas inlets 34 may be affixed to supply a gas pressure 36 to the interior portion 18 of the insert 20 for assisting the resin extraction. In one arrangement, the supplied gas may be carbon dioxide (CO₂), although other types of gases may be used in some cases.

During the centrifugation 23 of the pieces 14 and the first solvent 22, the first solvent 22 may soften the composite material, allowing at least a portion of the resin to be drawn out of the composite material and into the first solvent 22. In addition, the rotation 38 of the centrifuge insert 20 about its longitudinal axis 40 may cause the extraction 41 of the first solvent carrying at least a portion of the resin 30 through the perforations 28 of the insert 20 (see FIG. 4). In particular, the first solvent 22 and the resin 30 may be extracted radially outward through the perforations 28 and into a reservoir 44, leaving carbon fiber 46 at least partially separated from the resin collected in the interior portion 18 of the insert 20. The reservoir 44 may generally be located between a wall 48 of the centrifuge 24 and an outer surface 50 of the centrifuge insert 20. The gas pressure 36 applied to the interior portion 18 of the insert 20 may further assist in pushing the solvent and the resin through the perforations 28 and into the reservoir 44. Furthermore, in order to prevent the resin from adhering to the wall 26 of the insert 20 during extraction, the wall 26 may be coated with a suitable composition such as poly(1,1,2,2-tetrafluoroethylene). It is also noted that the interior portion 18 of the insert 20 may have projections 52 that project radially inward and divide the interior portion 18 into a number of carbon fiber collection chambers.

When using methyl acetate as the first solvent, applicants have found sufficient resin extraction from carbon fiber composites after about four days of centrifugation at room temperature and at a rotation speed of about 100 rotations per minute (rpm) under a pressurized atmosphere of about 20 pounds per square inch (psi) of CO₂. It will be understood, however, that the centrifugation time, temperature, rotation speed, and CO₂ (or other gas) pressure may vary in practice depending on a number of considerations such as the degree of resin impregnation, the type of resin, the structure of the carbon fiber (woven, nonwoven, etc), the curing time of the composite part, the choice of solvent, and other conditions.

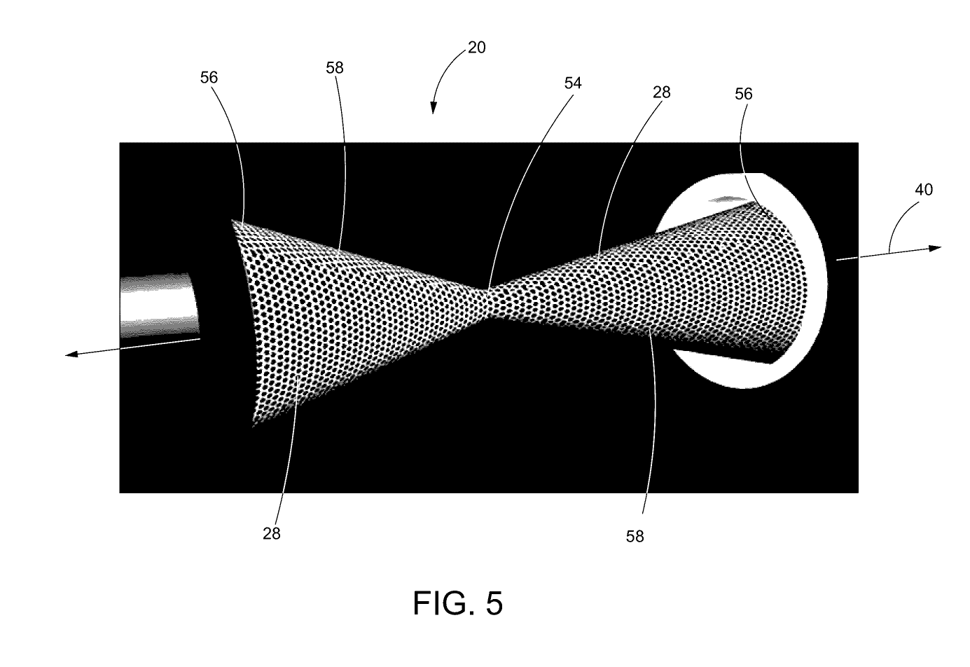

With reference to FIGS. 4-5, further details of the centrifuge insert 20 will now be described. The insert 20 may have a double-conical shape in which a radial diameter (d) of the insert 20 increases from a center 54 to each of two ends 56 located on opposing axial sides of the insert 20 with respect to the longitudinal axis 40. In other words, the double-conical shape of the insert 20 may be formed by two, identically-shaped cones 58, wherein the apices of the two cones 58 are joined to form the center 54 of the insert 20. As opposed to a cylindrical structure with a uniform diameter, the double-conical shape of the insert 20 provides a gradation of rotation speeds along the longitudinal length of the insert 20 during centrifugation, with the wider diameter ends 56 rotating at slower speeds than the smaller diameter center 54. The varying rotation speeds along the length of the insert 20 may provide improved resin extraction and reduced extraction time, particularly when the pieces 14 of the composite part accumulate into clumps of varying sizes in the first solvent. Furthermore, the perforations 28 of the insert 20 may gradually increase in diameter from the center 54 to each of the ends 56, as best shown in FIG. 4. For example, the diameter of the perforations 28 may increase by a factor of four from the center 54 of the insert 20 to the ends 56 of the insert 20. As one non-limiting example, the diameter of the perforations 28 may increase from about one centimeter near the center 54 of the insert 20 to about four centimeters near the ends 56. The gradation of the perforation diameters may further assist in resin extraction when clumps of composite material of varying sizes accumulate during centrifugation.

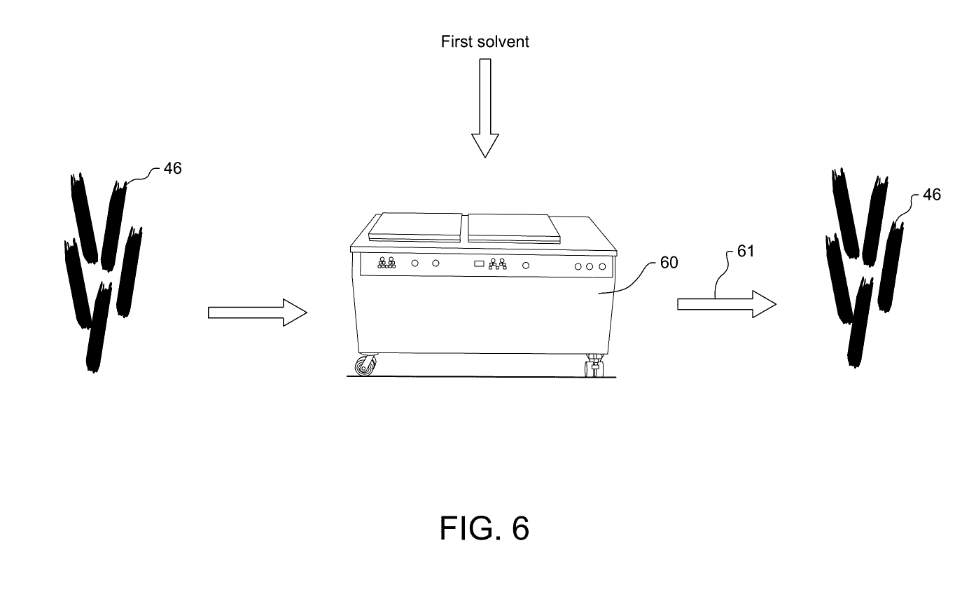

After completion of the first centrifugation step 23, the carbon fiber 46 may be collected from the interior portion 18 of the insert 20 and placed in an ultrasonic cleaner 60 with a second batch of the first solvent, as depicted in FIG. 6. The mixture of the carbon fiber 46 and the first solvent may then be sonicated 61 for a suitable time to further agitate and break-up the fibers and expose or release any residual resin embedded therein. During the sonication, some of the residual resin may be released from the carbon fiber 46 and drawn into the first solvent to further purify the carbon fiber 46. However, even after collection of the carbon fiber 46 from the ultrasonic cleaner 60, some of the resin may still be adhered to the carbon fiber 46, thus necessitating a further extraction step as will be described below. The first solvent used for the sonication may be methyl acetate, although other suitable solvents may also be used. It is also noted that, in some cases, the solvents used for the sonication and the first centrifugation step 23 may differ from each other. When using methyl acetate as a solvent for the sonication, applicants have found that sonication at room temperature and an ultrasonic frequency of between about 25 to about 50 hertz (Hz) for a period of about one hour is sufficient to suitably break-up the carbon fibers for further extraction.

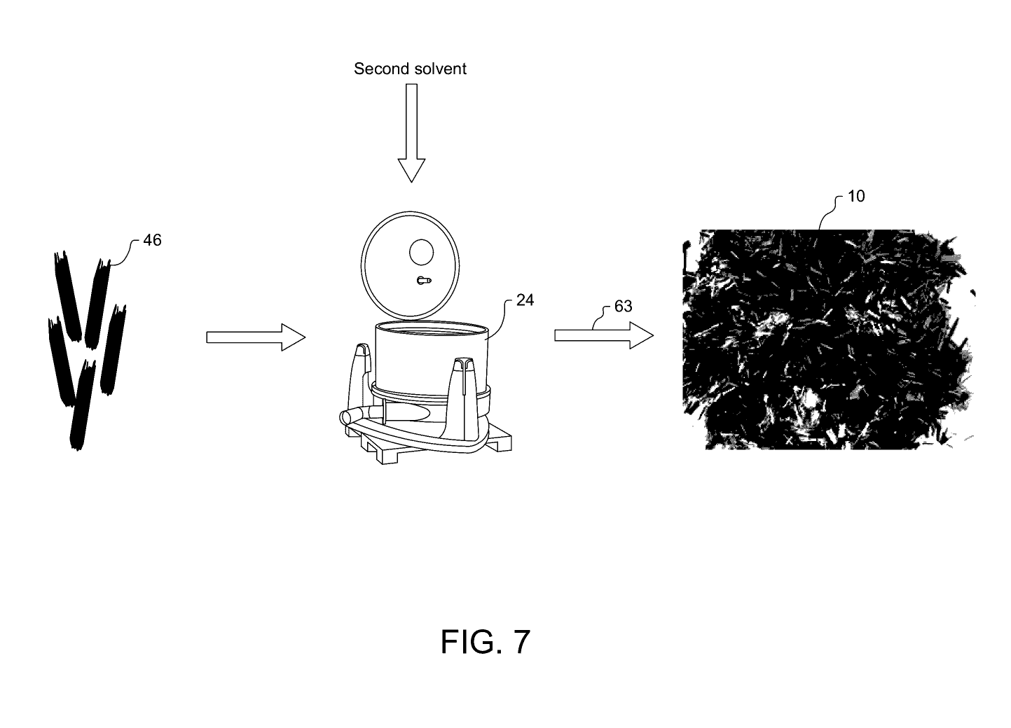

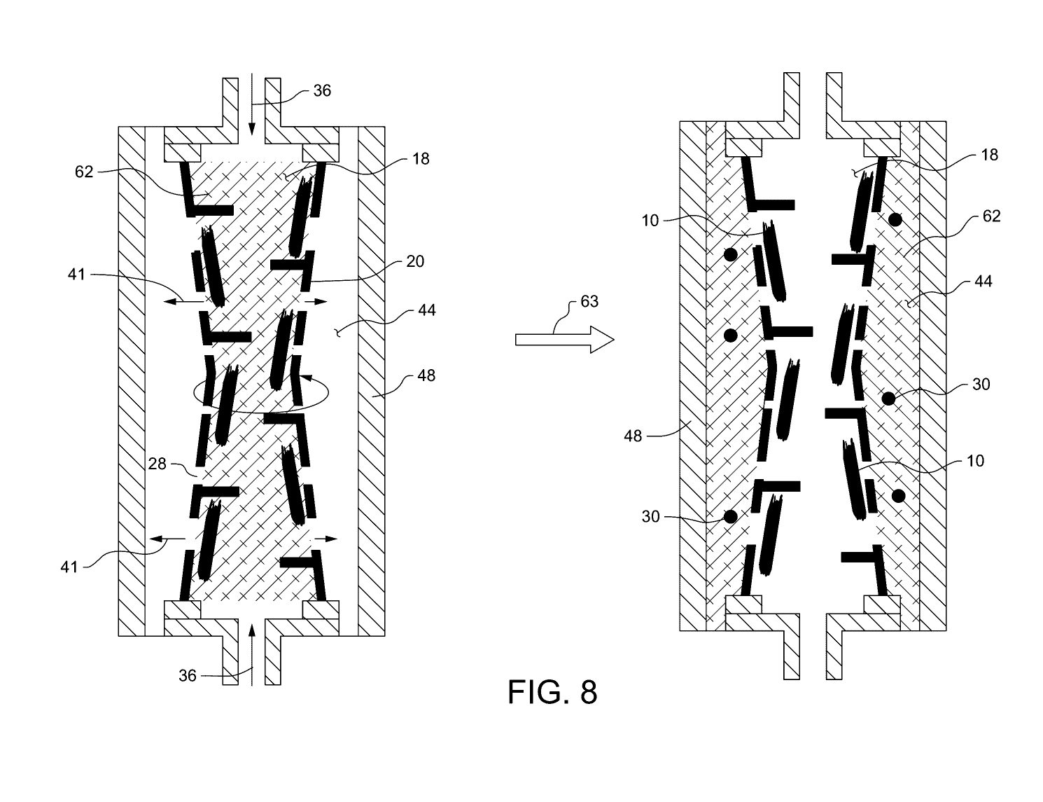

Turning now to FIGS. 7-8, the carbon fiber 46 may be subjected to a second centrifugation step 63 after collection from the ultrasonic cleaner 60. Specifically, the carbon fiber 46 may be placed in the interior portion 18 of the centrifuge insert 20 along with a second solvent 62, and centrifuged for a suitable time to fully purify the carbon fiber 46 from any residual resin. The second solvent 62 may be capable of penetrating and softening the carbon fiber 46 to release or expose any resin buried therein without damaging the carbon fiber. In addition, the resin may have a higher affinity for the second solvent 62 than the carbon fiber 46 to allow the resin to be at least partially liquefied into or dissolved in the second solvent, leaving the carbon fiber in solid form. For example, the second solvent 62 may be 2-methyl-tetrahydrofuran, although other types of solvents may be used instead. Like methyl acetate, 2-methyl-tetrahydrofuran has the advantage of being biodegradable and reusable.

During the centrifugation 63, the second solvent 62 and any remaining resin 30 may be extracted 41 through the perforations 28 of the insert 20 and into the reservoir 44, as best shown in FIG. 8. Thus, purified, reclaimed carbon fiber 10 may remain in solid form on the interior portion 18 of the insert 20. As explained above, a gas pressure 36 may also be applied to the centrifuge insert 20 to further assist in the extraction. When using 2-methyl-tetrahydrofuran as the second solvent 62 for the second centrifugation step, applicants have found that a centrifugation time of about four hours at room temperature, a rotation speed of about 100 rpm, and a CO₂ gas pressure of about 20 psi is sufficient to provide the reclaimed carbon fiber 10 fully separated from the resin. It will be understood, however, that the centrifugation time, temperature, rotation speed, and gas pressure may vary depending on a number of conditions.

Upon completion of the second centrifugation step 63, the carbon fiber may be collected from the interior portion 18 of the insert 20 to provide the purified, reclaimed carbon fiber 10 (see FIG. 7). Due to the chopping of the composite part 12 into the smaller pieces 14, and the agitation of the smaller pieces 14 during the centrifugation steps and sonication, the purified carbon fiber 10 may be shortened and uncombed (or randomly-oriented). In any event, applicants have shown as much as 98-99% recovery of purified carbon fiber from waste carbon fiber composite parts by following the method disclosed herein. Example 1 below provides a sample protocol used to successfully reclaim pure carbon fiber from a waste composite part in accordance with the method disclosed herein.

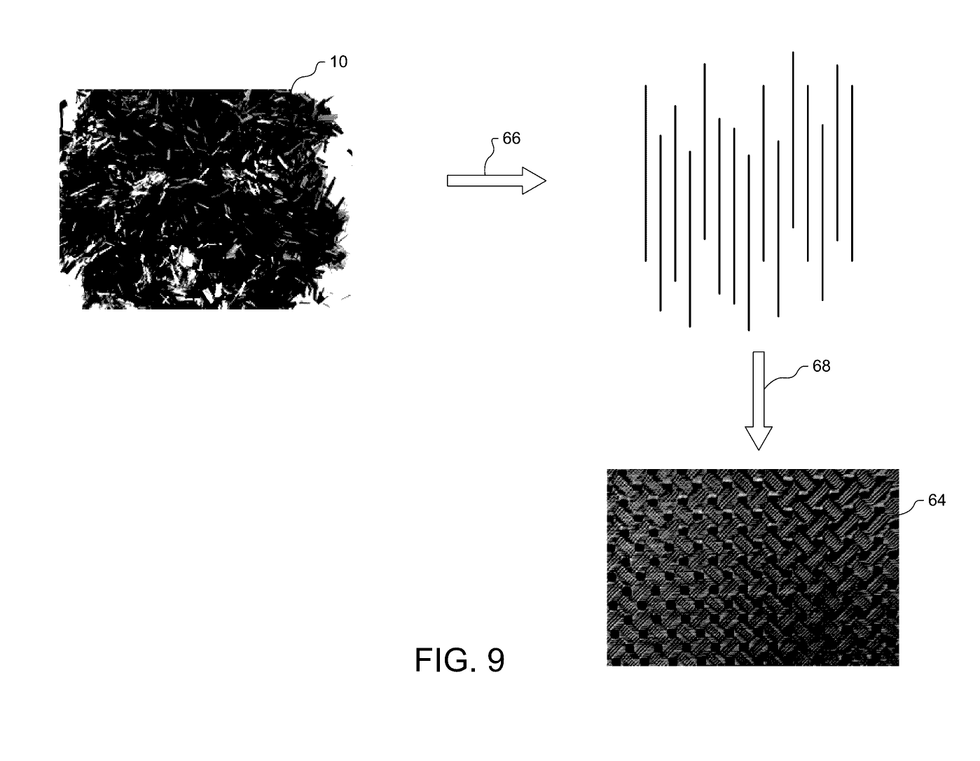

If desired, the reclaimed carbon fiber 10 may be forged into one or more carbon fiber sheets 64 for re-use in product manufacturing. Forging of the reclaimed carbon fiber 10 into the carbon fiber sheet 64 may be carried out as shown in FIG. 9. Specifically, the reclaimed carbon fiber 10 may be combed 66 to align the carbon fibers in a common direction, as shown. The combing of the reclaimed carbon fiber 10 may be achieved using a combing tool apparent to those with ordinary skill in the art. Once combed, the aligned carbon fibers may then be pressed 68 under heat and pressure into the carbon fiber sheet 64 using a suitable press. Pressing of the carbon fiber into the carbon fiber sheet 64 may be carried out at temperatures of between about 130° C. to about 160° C., and at pressures of about 100 psi to about 1500 psi, although other temperatures and pressures may be used in some cases.

Notably, applicants have found that carbon fiber sheets 64 fabricated from the reclaimed carbon fiber 10 according to the methods disclosed herein have nearly identical interfacial shear and tensile strengths as carbon fiber sheets forged from virgin carbon fiber (see Table 1), thus emphasizing the suitability of the reclaimed carbon fiber 10 for reuse.

TABLE 1
Tensile and Interfacial Shear Strengths of Carbon Fiber Sheets
Forged from VirginCarbon Fiber and Reclaimed Carbon Fiber¹

| Carbon Fiber Sheet | Tensile Strength | Interfacial Sheet Shear |
|---|---|---|
| Forged from: | (MPa)¹ | Strength (MPa)¹ |
| Virgin Carbon Fiber | 60.3 | 4017 |
| Reclaimed Carbon Fiber² | 59.7 | 3994 |

¹MPa = megapascals;
²Carbon fiber reclaimed according to the sample protocol of Example 1.

### EXAMPLE 1

Waste carbon fiber composite material (˜3.5 pounds) was chopped into about one inch square pieces in a Ceselcan KF chopping machine. The chopped pieces were then centrifuged in methyl acetate in the centrifuge insert 20 disclosed herein for a period of about four days at ambient temperature, a rotation rate of about 100 rpm, and a carbon dioxide pressure of about 20 psi. Carbon fiber was collected from the centrifuge insert and sonicated at 25-50 Hz in methyl acetate at ambient temperature for about one hour in an Ultra Clean ultrasonic cleaner. Carbon fiber was collected from the ultrasonic cleaner and centrifuged in 2-methyl-tetrahydrofuran in the centrifuge insert for a period of about four hours at ambient temperature, a rotation rate of about 100 rpm, and a carbon dioxide pressure of about 20 psi. Carbon fiber was collected from the centrifuge insert and allowed to dry for a period of about one day to yield the purified, reclaimed carbon fiber (˜3 pounds).

### INDUSTRIAL APPLICABILITY

It can be seen from the above that the teachings of the present disclosure may find wide industrial applicability in a variety of settings including industries seeking lower cost carbon fiber and carbon fiber composite materials. The technology disclosed herein provides an efficient method to reclaim carbon fiber from waste composite materials in high purity and recovery yields (>95%). Specifically, sonication and centrifugation in selected solvents are used to break-up and soften the composite material to allow the release of resin from the carbon fiber into the solvents, and allow the resin and solvents to be extracted from the solid carbon fiber. As disclosed herein, suitable solvents for this purpose may be methyl acetate and 2-methyl-tetrahydrofuran, both of which have the advantage of being biodegradable and reusable. The technology disclosed herein also provides a novel centrifuge insert specifically designed to optimize resin extraction from the carbon fiber during centrifugation. Namely, the centrifuge insert includes a double-conical shape that allows for a gradation of rotation speeds, as well as a perforated body with a gradation of hole sizes to improve resin extraction.

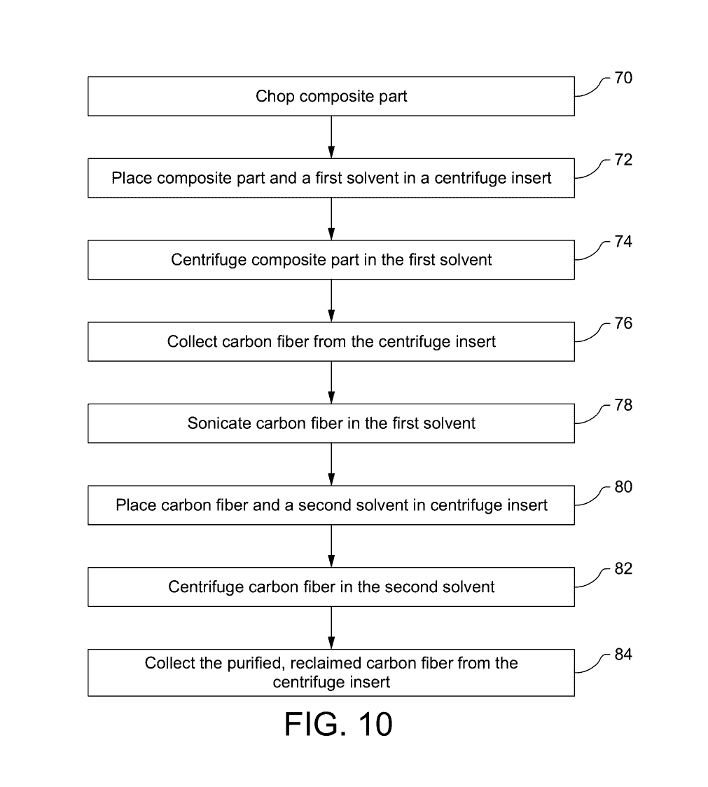

A flowchart showing a series of steps that may be involved in reclaiming pure carbon fiber from a waste composite part in accordance with the present disclosure is shown in FIG. 10. Beginning with a first block 70, the composite part 12 may be chopped into smaller pieces 14 using the chopping machine 16 or another chopping tool (also see FIG. 2). The chopped composite part may then be placed in the interior portion 18 of the centrifuge insert 20 in a bath of a first solvent, such as methyl acetate (block 72), and centrifuged in the first solvent to allow extraction the first solvent and at least a portion of the resin through the perforations 28 of the insert 20 into a collection reservoir 44 (block 74; also see FIGS. 3-4). Solid carbon fiber 46, at least partially separated from the resin, may be collected from the interior portion 18 of the centrifuge insert 20 (block 76), and then sonicated in a second bath of the first solvent (e.g., methyl acetate) (block 78) to further break-up the carbon fibers 46 and expose any resin deeply impregnated therein (also see FIG. 6).

After sonication, the solid carbon fiber pieces may be collected and placed in the centrifuge insert 20 in a bath of a second solvent, such as 2-methyl-tetrahydrofuran (block 80). Centrifugation of the carbon fiber in the second solvent according to a next block 82 may cause extraction of the second solvent and any remaining resin from the carbon fiber through the perforations 28 of the insert 20 into the collection reservoir 44 (see FIGS. 7-8). Upon completion of block 82, the purified and reclaimed carbon fiber 10 can be collected from the interior portion 18 of the insert 20 and dried according to a block 84.

The method disclosed herein thus provides access to purified carbon fiber from composite waste parts in high yields, an achievement heretofore unknown by applicants. The reclaimed carbon fiber may be recycled and reused in new products as a way to provide more cost-effective carbon fiber composite parts. For example, as disclosed herein, applicants have shown that the reclaimed carbon fiber may be forged into new carbon fiber sheets with strength profiles nearly identical to the strength profiles of carbon fiber sheets made from virgin carbon fiber. It is expected that the technology disclosed herein may find wide industrial applicability in a wide range of areas such as, but not limited to, automotive, marine, military, aerospace, and electronic applications.

What is claimed is:

1. Carbon fiber reclaimed from a composite part, the composite part including the carbon fiber and a resin, the carbon fiber being reclaimed from the composite part by a method comprising:
placing the composite part and a first solvent in an interior portion of a centrifuge insert, the centrifuge insert being defined by a wall having a plurality of perforations extending therethrough;
centrifuging the composite part and the first solvent contained in the centrifuge insert to allow extraction of the first solvent and at least a portion of the resin through the perforations of the centrifuge insert; and
allowing the carbon fiber to collect in the interior portion of the centrifuge insert, the carbon fiber collected in the interior portion of the centrifuge insert being at least partially separated from the resin.

2. The carbon fiber of claim 1, wherein the method further comprises:
collecting the carbon fiber from the interior portion of the centrifuge insert; and
sonicating the collected carbon fiber in a second batch of the first solvent.

3. The carbon fiber of claim 2, wherein the method further comprises:
placing the sonicated carbon fiber and a second solvent in the interior portion of the centrifuge insert;
centrifuging the carbon fiber and the second solvent contained in the centrifuge insert to allow extraction of the second solvent and a remaining portion of the resin through the perforations; and
allowing the carbon fiber to collect in the interior portion of the centrifuge insert, the carbon fiber collected in the interior portion of the centrifuge insert being fully separated from the resin.

4. The carbon fiber of claim 3, wherein the first solvent is methyl acetate and the second solvent is 2-methyl-tetrahydrofuran.

5. The carbon fiber of claim 3, wherein the centrifuge insert includes a double-conical shape having a center and two opposing ends, the centrifuge insert gradually increasing in diameter from the center to each of the two opposing ends.

6. The carbon fiber of claim 5, wherein the perforations of the centrifuge insert gradually increase in diameter from the center to the two opposing ends.

7. The carbon fiber of claim 6, wherein the centrifuge insert is coated with poly(1,1,2,2-tetrafluoroethylene).

8. The carbon fiber of claim 5, wherein the method further comprises chopping the composite part into smaller pieces prior to placing the composite part and the first solvent in the centrifuge insert.

9. The carbon fiber of claim 5, wherein centrifuging the composite part and the first solvent contained in the centrifuge insert is carried out under a pressurized CO₂ atmosphere.

10. The carbon fiber of claim 5, wherein centrifuging the composite part and the first solvent contained in the centrifuge insert is carried out for a period of about four days.

11. The carbon fiber of claim 5, wherein centrifuging the carbon fiber and the second solvent contained in the centrifuge insert is carried out under a pressurized CO₂ atmosphere.

12. The carbon fiber of claim 5, wherein centrifuging the carbon fiber and the second solvent contained in the centrifuge insert is carried out for a period of about four hours.

13. The carbon fiber of claim 5, wherein the carbon fiber reclaimed from the composite part is forged into a carbon fiber sheet.

14. The carbon fiber of claim 13, wherein the carbon fiber reclaimed from the composite part is forged into the carbon fiber sheet by a process comprising:
combing the carbon fibers to align the carbon fibers in a common direction; and
pressing the combed carbon fibers under pressure and heat to form the carbon fiber sheet.

15. A method for reclaiming carbon fiber from a composite part, the composite part including the carbon fiber and a resin, the method comprising:
placing the composite part and methyl acetate in an interior portion of a centrifuge insert having a double-conical shape, the centrifuge insert being defined by a wall having a plurality of perforations extending therethrough;
centrifuging the composite part and the methyl acetate contained in the centrifuge insert to allow extraction of the methyl acetate and at least a portion of the resin through the perforations of the centrifuge insert; and
allowing the carbon fiber to collect in the interior portion of the centrifuge insert, the carbon collected in the interior portion of the centrifuge insert being at least partially separated from the resin.

16. The method of claim 15, wherein the method further comprises:
collecting the carbon fiber from the interior portion of the centrifuge insert; and
sonicating the collected carbon fiber in methyl acetate.

17. The method of claim 16, wherein the method further comprises:
placing the sonicated carbon fiber and 2-methyl-tetrahydrofuran in the interior portion of the centrifuge insert;
centrifuging the carbon fiber and the 2-methyl-tetrahydrofuran contained in the centrifuge insert to allow extraction of the 2-methyl-tetrahydrofuran and a remaining portion of the resin through the perforations; and
allowing the carbon fiber to collect in the interior portion of the centrifuge insert, the carbon fiber collected in the interior portion of the centrifuge insert being fully separated from the resin.

18. The method of claim 17, wherein the method further comprises chopping the composite part into smaller pieces prior to placing the composite part and the methyl acetate in the centrifuge insert.

19. The method of claim 18, wherein centrifuging the composite part and the methyl acetate contained in the centrifuge insert is carried under a pressurized CO₂ atmosphere, and wherein centrifuging the carbon fiber and the 2-methyl-tetrahydrofuran contained in the centrifuge insert is carried out under a pressurized CO₂ atmosphere.

20. An centrifuge insert for reclaiming carbon fiber from a composite part, the composite part including the carbon fiber and a resin, the centrifuge insert comprising:
a wall defining the centrifuge insert;
a center;
two ends on opposing axial sides of the centrifuge insert with respect to a longitudinal axis of the centrifuge insert, a radial diameter of the centrifuge insert increasing gradually from the center to each of the two ends such that the centrifuge insert has a double-conical shape;
a plurality of perforations extending through the wall; and
an interior portion configured to contain the composite part and a solvent during centrifugation, the resin and the solvent being extracted through the perforations during centrifugation of the composite part, leaving the carbon fiber at least partially purified from the resin in the interior portion.
